(19) United States
(12) Patent Application Publication
(10) Pub. No.: US 2025/0383788 A1
(43) Pub. Date: Dec. 18, 2025

(54) MEMORY SYSTEM PURGE OPERATIONS WITH INTERLEAVED ACCESS COMMANDS

(71) Applicant: Micron Technology, Inc., Boise, ID (US)

(72) Inventors: Giuseppe D'Eliseo, Caserta (IT); Francesco Basso, Portici (IT); Francesco Falanga, Quarto (IT); Luigi Paglialunga, Frattamaggiore (IT); Giuseppe Ferrari, Napoli (IT); Dionisio Minopoli, Frattamaggiore (IT)

(21) Appl. No.: 19/233,607

(22) Filed: Jun. 10, 2025

Related U.S. Application Data
(60) Provisional application No. 63/660,105, filed on Jun. 14, 2024.

(51) Int. Cl. G06F 3/06

(52) U.S. Cl. CPC G06F 3/0622; G06F 3/0659; G06F 3/0673

(57) ABSTRACT

Methods, systems, and devices for memory system purge operations with interleaved access commands are described. The described techniques provide for a memory system to perform a purge operation that enables the execution of access commands while the purge operation is in progress. For example, the memory system may receive a command indicating to perform a sliced purge operation and may begin erasing invalid data segments. The memory system may execute an access operation in between removing segments of invalid data, and may store information indicating a status of the data at a time when the command initiating the purge operation is received. The memory system may reference the information when removing segments of the invalid data after performing the access operation, which may support the memory system completing the purge operation without additional invalid data created by the access operation impacting the purge operation.

### CROSS REFERENCE

The present Application for Patent claims priority to U.S. Patent Application No. 63/660,105 by D'Eliseo et al., entitled “MEMORY SYSTEM PURGE OPERATIONS WITH INTERLEAVED ACCESS COMMANDS,” filed Jun. 14, 2024, which is assigned to the assignee hereof, and which is expressly incorporated by reference in its entirety herein.

### TECHNICAL FIELD

The following relates to one or more systems for memory, including memory system purge operations with interleaved access commands.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports memory system purge operations with interleaved access commands in accordance with examples as disclosed herein.

FIG. 2 shows an example of a process that supports memory system purge operations with interleaved access commands in accordance with examples as disclosed herein.

FIG. 3 shows a block diagram of a memory system that supports memory system purge operations with interleaved access commands in accordance with examples as disclosed herein.

FIG. 4 shows a block diagram of a host system that supports memory system purge operations with interleaved access commands in accordance with examples as disclosed herein.

FIGS. 5 and 6 show flowcharts illustrating a method or methods that support memory system purge operations with interleaved access commands in accordance with examples as disclosed herein.

### DETAILED DESCRIPTION

Memory systems may be configured to store and maintain information in one or more arrays of memory cells. In some examples, a memory system may perform memory management operations to improve data storage capabilities of one or more memory devices. Such memory management operations may include a purge operation, among other types of memory management operations. A purge operation may support the memory system removing invalid data (e.g., data associated with logical block data that is no longer valid) stored to physical blocks of a memory device. For example, the memory system may receive a command from a host system to perform a purge operation on a set of physical blocks and may execute the purge operation by erasing invalid data from the physical blocks and refreshing the blocks to retain valid data. In some cases, the host system may refrain from (e.g., be disallowed from) issuing other types of commands while a purge operation is in progress. For example, the host system may wait for previously queued commands to finish before issuing a command to perform a purge operation (or may include the purge operation at the end of a command queue) and may wait until the purge operation complete before issuing a subsequent command. If the host system identifies a command with relatively high priority (e.g., an urgent command) that is to be executed while the memory system is performing a purge operation, the host system may interrupt the purge operation. Such interruption may include the host system transmitting an interrupt indication to the memory system, receiving an interrupt confirmation from the memory system, and issuing the high priority command once interruption is confirmed. To restart the purge operation after the interruption, the memory system may, in some cases, start from the beginning of the purge (e.g., may repeat erasing data from blocks that the memory system erased prior to the interruption). However, such techniques may incur additional latency and overhead in the system due to, for example, exchanging signaling for the interruption, reissuing the purge command, and re-executing the purge operation from the beginning, thereby reducing performance of purge operations and other operations at the memory system. Further, re-executing the purge operations may result in multiple erase operations being applied to the same set of blocks, which may increase wear on the blocks and reduce an operative lifespan of the blocks.

Techniques described herein provide for a memory system to support a type of purge operation that enables the execution of access commands (e.g., read commands or write commands) while the purge operation is in progress. Such a purge operation may be referred to as a sliced purge operation, in some examples, where invalid data identified to be deleted during the purge operation may be removed in segments (e.g., slices, subsets, portions, chunks, or the like). For example, the memory system may receive a command indicating the sliced purge operation and a command (e.g., the same command or a separate command) initiating the purge operation, and the memory system may take a snapshot of the data blocks to be purged in response to the command. After obtaining the snapshot, the memory system may begin erasing data from blocks including invalid data in segments (e.g., in accordance with the purge operation). If the memory system receives an access command while the sliced purge operation is in progress (e.g., one or more segments of invalid data remain to be erased), the memory system may execute the access operation in between removing segments of invalid data. To prevent subsequent segment removals from being impacted by the access operation (e.g., if the access operation results in a status of the data being changed), and to refrain from restarting the purge operation after the access operation, the memory system may store information indicating a status of the data (e.g., within the snapshot). The memory system may reference the snapshot when removing segments of the invalid data after performing the access operation, which may support the memory system completing the purge operation without additional invalid data created by the access operation impacting the purge operation (e.g., new invalid data not present in the snapshot may be removed via a subsequent purge operation). Such techniques may improve the performance of purge operations at the memory system (e.g., in comparison to other types of purge operations, such as a continuous purge operation) by eliminating or otherwise mitigating latency associated with interleaving access commands while a purge operation is in progress.

In addition to applicability in memory systems as described herein, techniques for purge operations with interleaved access commands may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds while maintaining reliability of purge operations, which may decrease processing or latency times, improve response times, or otherwise improve user experience, among other benefits.

In addition to applicability in memory systems described herein, techniques for purge operations with interleaved access commands may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by maintaining the accuracy and reliability of purge operations, and may prevent or mitigate unauthorized access to data or other information and incur lower latency costs, among other benefits.

Features of the disclosure are illustrated and described in the context of systems, devices, and circuits. Features of the disclosure are further illustrated and described in the context of a process and flowcharts.

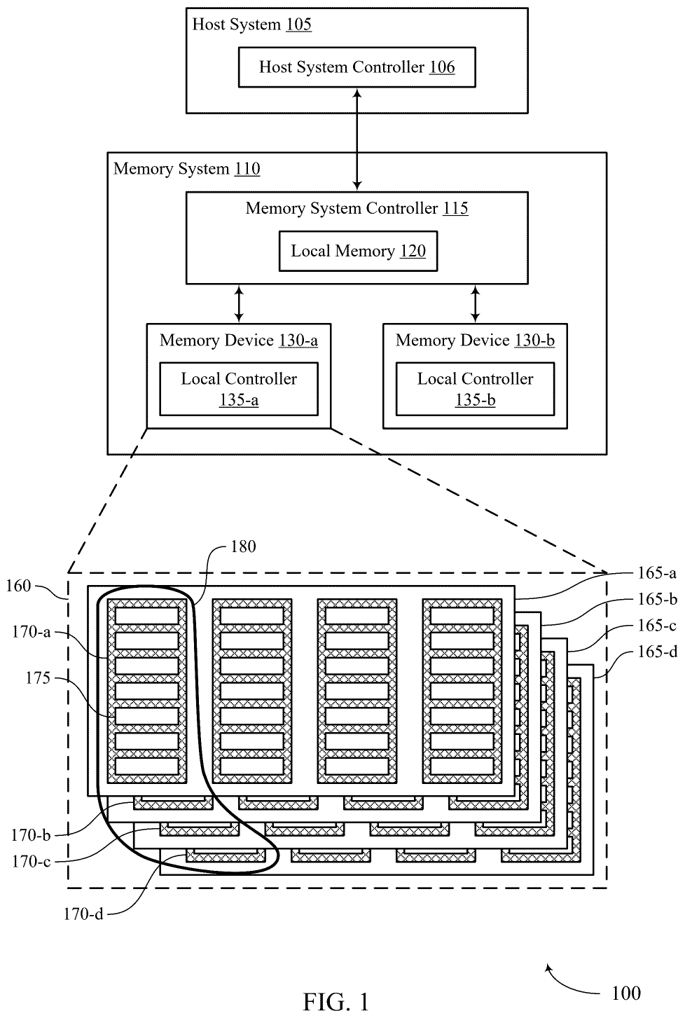

FIG. 1 shows an example of a system 100 that supports memory system purge operations with interleaved access commands in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples of the system 100, a memory system 110 may perform memory management operations, such as a purge operation, which may support the memory system 110 removing invalid data stored to physical blocks of a memory device. For example, the memory system 110 may receive a command from a host system 105 to perform a purge operation on a set of physical blocks 170 and may execute the purge operation by erasing invalid data from the physical blocks 170 and refreshing the blocks 170 to retain valid data. In some cases, the host system 105 may refrain from issuing other types of commands while a purge operation is in progress. For example, the host system 105 may wait for previously queued commands to finish before issuing a command to perform a purge operation (or may include the purge operation at the end of a command queue) and may wait until the purge operation complete before issuing a subsequent command. If the host system 105 identifies a command to be executed with relatively high priority (e.g., an urgent command) while the memory system 110 is performing a purge operation, the host system 105 may interrupt the purge operation. Such interruption may include the host system 105 transmitting an interrupt indication to the memory system 110, receiving an interrupt confirmation from the memory system 110, and issuing the command once interruption is confirmed. However, such techniques may incur additional latency in the system 100, such as time associated with communicating the interrupt command and confirmation, reissuing the purge command, and re-executing the purge operation, thereby limiting performance of purge operations at the memory system 110.

According to the techniques described herein, the memory system 110 may support a type of purge operation that enables the execution of access commands (e.g., read commands or write commands) while the purge operation is in progress. Such a type of purge operation may be referred to as a sliced purge operation, where invalid data identified to be deleted during the purge operation may be removed in segments (e.g., slices, subsets, portions, chunks, or the like). For example, the memory system 110 may receive a command indicating the sliced purge operation and a command (e.g., the same command or a separate command) initiating the purge operation, and the memory system 110 may begin erasing data from blocks 170 including invalid data in segments (e.g., in accordance with the purge operation). If the memory system 110 receives an access command while the sliced purge operation is in progress (e.g., one or more segments of invalid data remain to be erased), the memory system 110 may execute the access operation in between removing segments of invalid data. In some examples, to prevent subsequent segment removals from being impacted by the access operation (e.g., if the access operation results in a status of the data being changed), the memory system 110 may store information indicating a status of the data (which may be referred to as a snapshot of the data) at a time when the command initiating the purge operation is received. For example, the memory system 110 may reference the snapshot when removing segments of the invalid data after performing the access operation, which may support the memory system 110 completing the purge operation without additional invalid data created by the access operation impacting the purge operation (e.g., new invalid data not present in the snapshot may be removed via a subsequent purge operation). Such techniques may improve the performance of purge operations at the memory system 110 (e.g., in comparison to other types of purge operations, such as a continuous purge operation) by eliminating or otherwise mitigating latency associated with interleaving access commands while a purge operation is in progress

The system 100 may include any quantity of non-transitory computer readable media that support memory system purge operations with interleaved access commands. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

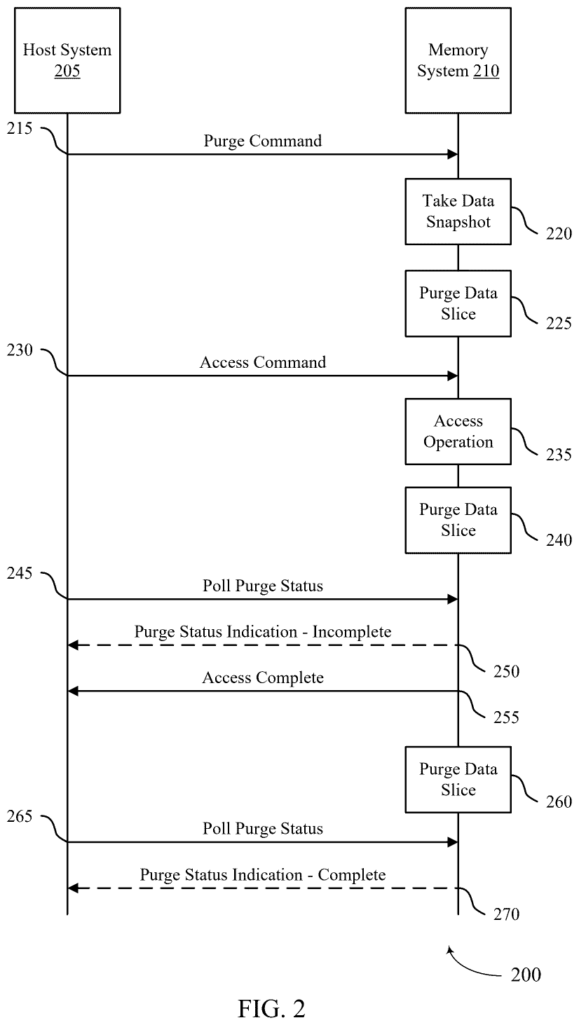

FIG. 2 shows an example of a process 200 that supports memory system purge operations with interleaved access commands in accordance with examples as disclosed herein. The process 200 may implement, or be implemented by, one or more aspects of the system 100. For example, the process 200 may show signaling and operations performed by a host system 205 and a memory system 210, which may be examples of corresponding devices described with reference to FIG. 1. In some cases, the process 200 may support the memory system 210 removing invalid data in accordance with a sliced purge operation, which may enable the memory system 210 to execute one or more access commands while the purge operation is in progress.

Aspects of the process 200 may be implemented by one or more controllers, among other components. Additionally, or alternatively, aspects of the process 200 may be implemented as instructions stored in one or more memories (e.g., firmware stored in one or more memories coupled with the host system 205 and/or the memory system 210). For example, the instructions, when executed by one or more controllers (e.g., a memory system controller 115 of the memory system 210), may cause the one or more controllers (or a device or a system) to perform the operations of the process 200. Alternative examples of the following may be implemented, where some steps are performed in a different order or not at all. Additionally, some steps may include additional features not mentioned below.

At 215, a purge command may be communicated. For example, a host system (e.g., the host system 205) may transmit the purge command to a memory system (e.g., the memory system 210). The purge command may be received at a controller of the memory system 210 (e.g., a memory system controller 115 described with reference to FIG. 1). In some examples, the purge command may include a trigger to perform a purge operation to remove data (e.g., invalid data) stored to one or more blocks of memory cells of the memory system 210. Additionally, or alternatively, the purge command may indicate a first type of the purge operation, where the first type of purge operation may be a sliced purge operation. The sliced purge operation may indicate that the memory system 210 is capable of performing access operations after the purge operation is initiated and before the purge operation is complete. For example, performing the purge operation in accordance with the sliced purge operation may include the memory system 210 removing invalid data in segments (e.g., removing data in portions within a block, on a per-block basis, in subsets of the one or more blocks, or any combination thereof) such that access operations may be performed in between the removal of segments.

In some examples, in response to (e.g., based on, after) the indication of the first type of purge operation, the memory system 210 may select the first type of purge operation from a set of multiple types of purge operations (e.g., including at least the first type of purge operation and a second type of purge operation corresponding to a continuous purge operation, among other example types of purge operations). In some cases, the memory system 210 may receive a single command indicating the first type of purge operation and including the trigger to initiate the purge operation of the first type. Alternatively, the memory system 210 may receive separate commands indicating the first type of purge operation (e.g., via a first command) and triggering the purge operation of the first type (e.g., via a second command subsequent to the first command). In some examples, the first type of purge operation may be set at the memory system 210 (e.g., configured, defined in a product specification, indicated via a register or pin, or the like).

At 220, a snapshot of the data may be taken. For example, the memory system 210 may store, at a first time corresponding to reception of the purge command (e.g., the command triggering the purge operation), information that indicates a status of the invalid data to be removed as part of the purge operation. The information may include a list of blocks (e.g., a list of block indices) of the memory system 210 that include invalid data. The snapshot may provide for the memory system 210 to remove the invalid data from the blocks while refreshing the blocks (e.g., moving valid data from the block to another storage location prior to erasing the invalidated block) to maintain any valid data stored to the blocks. In some cases, taking the snapshot of the data may support the memory system 210 executing the purge operation while executing one or more access operations in between data erases (e.g., performed while the purge operation is in progress), and the one or more access operations may not impact the accuracy of the purge operation. The memory system 210 may store the snapshot of the data in volatile memory (e.g., a cache such as RAM) or may store the snapshot in different memory, such as non-volatile memory (e.g., NAND memory), or some other memory location.

At 225, a data slice may be purged. For example, the memory system 210 may erase a first subset (e.g., a first segment, a first slice) of the data according to the sliced purge operation and the snapshot of the data. The memory system 210 may erase the first subset of the data from one or more blocks of memory cells in response to determining that the first subset of the data includes invalid data in the snapshot obtained at 220. Additionally, or alternatively, in accordance with the purge operation, the memory system 210 may copy valid data included in a block associated with the first subset of the data to another block (e.g., a fresh block) prior to erasing the first subset of the data. In some examples, after erasing the first subset of the data, the memory system 210 may determine whether the purge operation is complete. For example, the memory system 210 may determine that the purge operation is not complete if at least some of the data indicated via the command (e.g., one or more additional subsets of invalid data) remains in the one or more blocks of the memory system. If none of the indicated invalid data remains, the memory system 210 may determine that the purge operation is complete.

At 230, an access command may be communicated. For example, the host system 205 may transmit an access command (e.g., a read command, a write command, or some other type of access command) to the memory system 210. The access command may indicate an access operation associated with the one or more blocks of memory cells, such as a read operation to retrieve data stored to the one or more blocks or a write operation to store data to the one or more blocks.

At 235, an access operation may be performed. For example, the memory system 210 may perform the access operation indicated by the access command. In some examples, performing the access operation may modify the status of the data to a second status (e.g., at a second time) that is different from the status associated with the snapshot (e.g., at the first time). For example, the access operation may be a write operation, and performing the write operation may invalidate data that was valid at the time of the snapshot (e.g., if the data includes LBAs corresponding to physical data overwritten by the write operation).

In some examples, the memory system 210 may perform the access operation in response to the access command and the memory system 210 completing a purge of a segment of data (e.g., in between data segment purges). Additionally, or alternatively, the memory system 210 may perform the access operation according to a first priority associated with the access operation being greater than a second priority of the purge operation. For example, if the access operation is associated with a relatively high priority, the memory system 210 may perform the access operation prior to erasing subsequent subsets of the data according to the first priority of the access operation being greater than the second priority of the purge operation. If the access operation is associated with a relatively low priority, the memory system 210 may refrain from performing the access operation and may instead erase one or more subsequent subsets of the data according to the first priority of the access operation being less than the second priority of the purge operation.

At 240, a data slice may be purged. For example, the memory system 210 may erase a second subset (e.g., a second segment, a second slice) of the data according to the sliced purge operation and the snapshot of the data. In some cases, the memory system 210 may erase the second subset of the data in accordance with the information indicating the status of the data at the first time and independent of the second status of the data at the second time. For example, when erasing the second subset of the data, the memory system 210 may ignore changes in the data incurred by performing the access operation (e.g., such that the purge operation may be completed without interruption), such as refraining from deleting newly invalidated data resulting from a write operation, among other examples.

At 245, a status of the purge operation may be polled. For example, the host system 205 may poll a pin or mode register (e.g., polling circuitry) of the memory system 210 configured to indicate the status of the purge operation. In some cases, a first value of the polling circuitry may indicate that the purge operation is not complete and a second value of the polling circuitry may indicate that the purge operation is complete. For example, in response to identifying that the purge operation is not complete, the memory system 210 may set (or maintain) the polling circuitry to the first value such that the host system 205 may identify that the purge operation is not complete. Additionally, or alternatively, the host system 205 may transmit a message (e.g., a status request) to the memory system 210 that queries whether the purge operation is complete and the memory system 210 may set the polling circuitry in response to the message.

At 250, a status of the purge operation may be indicated. For example, the host system 205 may identify that the purge operation is not complete in accordance with polling the pin or mode register and identifying that the pin or mode register is set to the first value. Additionally, or alternatively, the memory system 210 may transmit a message to the host system 205 (e.g., in response to the query) indicating that the purge operation is not complete. In some cases, the purge operation may not be complete if at least some of the invalid data remains in the one or more blocks.

At 255, an access operation status indication may be communicated. For example, the memory system 210 may transmit a message to the host system 205 indicating that the access operation is complete. In some cases, the memory system 210 may transmit the message after successfully storing data to a memory array or successfully retrieving data from a memory array. Alternatively, the memory system 210 may set a value of second polling circuitry (e.g., configured to indicate the status of the access operation) to a first value that indicates that the access operation is complete.

At 260, a data slice may be purged. For example, the memory system 210 may erase a third subset (e.g., a third segment, a third slice) of the data in accordance with the sliced purge operation and the snapshot of the data. In some cases, the memory system 210 may erase the third subset of the data in accordance with the information indicating the status of the data at the first time and independent of the second status of the data at the second time. In some examples, after erasing the third subset of the data, the memory system 210 may identify that the purge operation is complete. For example, the memory system 210 may identify an absence, after erasing the third subset of the data, of any of the invalid data indicated by the command (e.g., the third subset is a final subset of the data to be erased). In some cases, in response to identifying that the purge operation is complete, the memory system 210 may set the value of the polling circuitry to a second value indicating that the purge operation is complete. It should be noted that the memory system 210 may erase any quantity of subsets of the data (e.g., any quantity of one or more additional subsets may be purged between the second subset and third subset), and is not limited to the examples illustrated and described herein.

At 265, a status of the purge operation may be polled. For example, the host system 205 may poll the polling circuitry of the memory system 210 and may identify the polling circuitry set to the second value (e.g., indicating that the purge operation is complete). Additionally, or alternatively, the host system 205 transmit a message to the memory system 210 that queries whether the purge operation is complete, and the memory system 210 may set the value of the polling circuitry in response to the message. In some examples, the memory system 210 may delete the snapshot in response to detecting that the purge operation is complete to improve storage capacity. Additionally, or alternatively, the memory system 210 may maintain the snapshot until a subsequent snapshot for a subsequent purge operation is obtained, and the subsequent snapshot may overwrite the snapshot in memory.

At 250, a status of the purge operation may be indicated. For example, the host system 205 may identify that the purge operation is complete in accordance with polling the pin or mode register and identifying that the pin or mode register is set to the second value. Additionally, or alternatively, the memory system 210 may transmit a message to the host system 205 (e.g., in response to the query message) indicating that the purge operation is complete. In some cases, the polling circuitry may be set to the second value indicating that the purge operation is complete may if none of the invalid data remains in the one or more blocks (e.g., the sliced purge operation may be complete).

The memory system 210 as described herein may thereby perform a sliced purge operation by removing data in chunks (e.g., segments, subsets, or the like) and being available to perform access operations, if requested by the host system 205, between each chunk of data removal. By obtaining the snapshot of the data before erasing a first chunk of the data, the memory system 210 may refer to the snapshot when erasing each chunk of data, such that the purge operation is performed according to a first status of the data at a first time associated with a request or trigger for the purge operation, and any changes to the first status of the data in response to the access operations may not impact the result of the purge operation, but may instead be modified in subsequent purge operations. Such techniques may improve the flexibility and performance of purge operations at the memory system 210, particularly when the host system 205 identifies relatively urgent access commands to be performed while the purge operation is in progress.

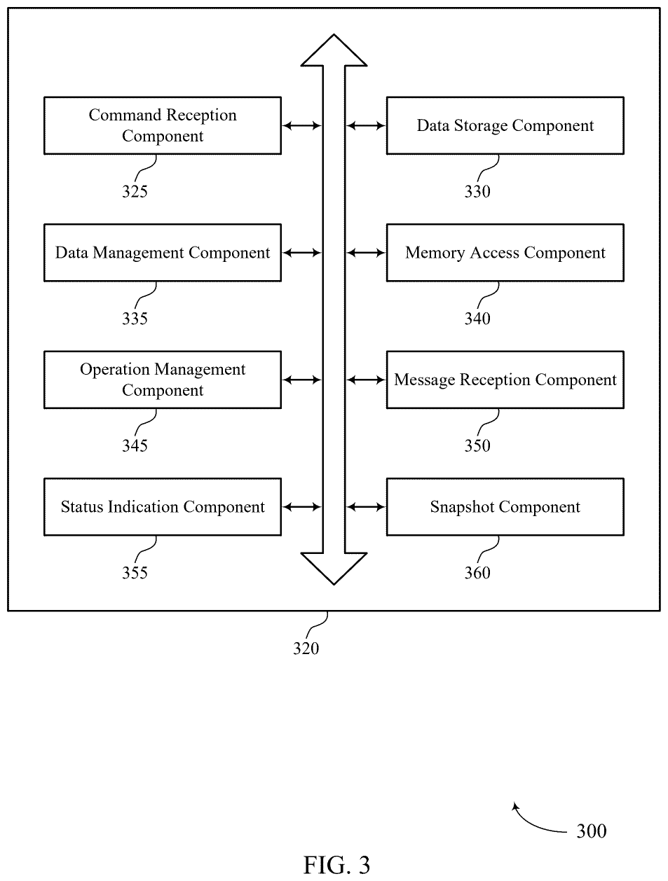

FIG. 3 shows a block diagram 300 of a memory system 320 that supports memory system purge operations with interleaved access commands in accordance with examples as disclosed herein. The memory system 320 may be an example of aspects of a memory system as described with reference to FIGS. 1 through 2. The memory system 320, or various components thereof, may be an example of means for performing various aspects of memory system purge operations with interleaved access commands as described herein. For example, the memory system 320 may include a command reception component 325, a data storage component 330, a data management component 335, a memory access component 340, an operation management component 345, a message reception component 350, a status indication component 355, a snapshot component 360, or any combination thereof. Each of these components, or components of subcomponents thereof (e.g., one or more processors, one or more memories), may communicate, directly or indirectly, with one another (e.g., via one or more buses).

The command reception component 325 may be configured as or otherwise support a means for receiving a command that indicates to perform a purge operation associated with removal of data stored to one or more blocks of memory cells of the memory system. The data storage component 330 may be configured as or otherwise support a means for storing, in response to the command received at a first time, information that indicates a status, at the first time, of the data stored to the one or more blocks of memory cells. The data management component 335 may be configured as or otherwise support a means for erasing, in accordance with the purge operation and storing the information, a first subset of the data from the memory system. In some examples, the command reception component 325 may be configured as or otherwise support a means for receiving, in response to erasing the first subset of the data, an access command that indicates an access operation associated with the one or more blocks of memory cells. The memory access component 340 may be configured as or otherwise support a means for performing the access operation associated with the one or more blocks of memory cells in accordance with the access command. In some examples, the data management component 335 may be configured as or otherwise support a means for erasing, after performing the access operation and in accordance with the information that indicates the status of the data at the first time, a second subset of the data.

In some examples, the operation management component 345 may be configured as or otherwise support a means for selecting a first type of purge operation from a plurality of types of purge operations supported by the memory system in response to the command indicating the first type of purge operation, where the first type of purge operation includes a sliced purge operation and a second type of purge operation of the plurality of types of purge operations includes a continuous purge operation.

In some examples, the sliced purge operation indicates that the memory system is capable of performing access operations after a second time at which the purge operation is initiated and before a third time at which the purge operation is complete. In some examples, performing the access operation is in accordance with the purge operation being the first type of purge operation including the sliced purge operation.

In some examples, to support erasing the second subset of the data, the data management component 335 may be configured as or otherwise support a means for erasing the second subset of the data in accordance with the information that indicates the status of the data at the first time and independent of the second status of the data at the second time.

In some examples, the message reception component 350 may be configured as or otherwise support a means for receiving, after receiving the access command and prior to erasing the second subset of the data, a first message that queries whether the purge operation is complete. In some examples, the status indication component 355 may be configured as or otherwise support a means for setting, in response to receiving the first message, a value of polling circuitry to a first value, the first value indicating that the purge operation is not complete in accordance with at least some of the data indicated via the command remaining in the one or more blocks of memory cells, the at least some of the data including at least the second subset of the data.

In some examples, the message reception component 350 may be configured as or otherwise support a means for receiving, after erasing the second subset of the data, a second message that queries whether the purge operation is complete. In some examples, the status indication component 355 may be configured as or otherwise support a means for setting, in response to receiving the second message, the value of the polling circuitry to a second value, the second value indicating that the purge operation is complete in accordance with an absence, after erasing the second subset of the data, of any of the data indicated via the command in the one or more blocks of memory cells, where the second subset of the data includes a final subset of the data to be erased.

In some examples, to support performing the access operation, the memory access component 340 may be configured as or otherwise support a means for performing the access operation prior to erasing the second subset of the data in accordance with a first priority associated with the access operation being greater than a second priority associated with the purge operation.

In some examples, to support storing the information that indicates the status, at the first time, of the data, the snapshot component 360 may be configured as or otherwise support a means for obtaining a snapshot of the data stored to the one or more blocks of memory cells. In some examples, to support storing the information that indicates the status, at the first time, of the data, the data storage component 330 may be configured as or otherwise support a means for storing the snapshot, where the information includes the snapshot.

In some examples, the status, at the first time, indicates that the first subset of the data and the second subset of the data include invalid data stored to the one or more blocks of memory cells.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

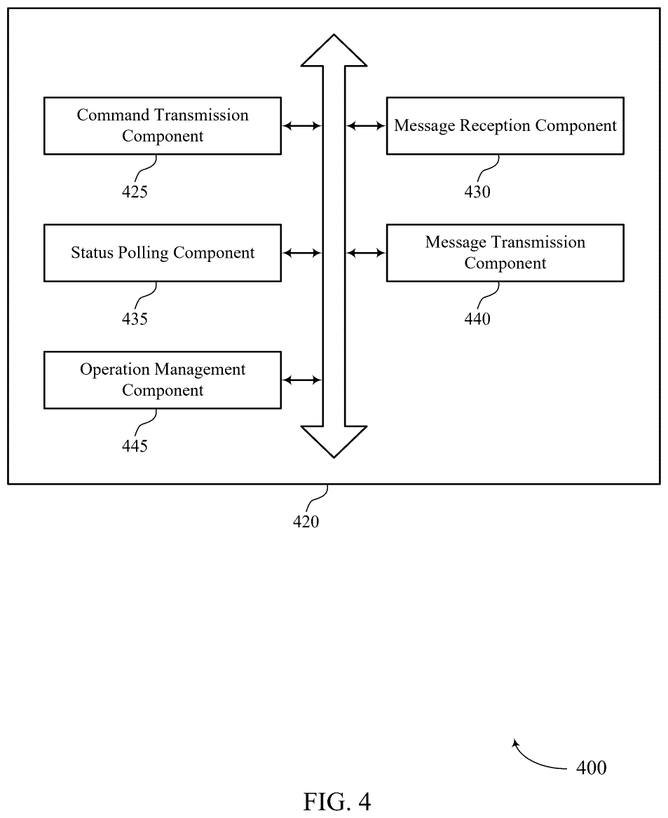

FIG. 4 shows a block diagram 400 of a host system 420 that supports memory system purge operations with interleaved access commands in accordance with examples as disclosed herein. The host system 420 may be an example of aspects of a host system as described with reference to FIGS. 1 through 2. The host system 420, or various components thereof, may be an example of means for performing various aspects of memory system purge operations with interleaved access commands as described herein. For example, the host system 420 may include a command transmission component 425, a message reception component 430, a status polling component 435, a message transmission component 440, an operation management component 445, or any combination thereof. Each of these components, or components of subcomponents thereof (e.g., one or more processors, one or more memories), may communicate, directly or indirectly, with one another (e.g., via one or more buses).

The command transmission component 425 may be configured as or otherwise support a means for transmitting a first command that indicates a first type of purge operation for a memory system. In some examples, the command transmission component 425 may be configured as or otherwise support a means for transmitting a second command that triggers a purge operation of the first type by the memory system, the purge operation including removal, in segments, of data stored to one or more blocks of memory cells of the memory system. In some examples, the command transmission component 425 may be configured as or otherwise support a means for transmitting, after transmitting the second command, an access command that indicates an access operation associated with the one or more blocks of memory cells of the memory system. The message reception component 430 may be configured as or otherwise support a means for receiving, in response to the access command, a first message that indicates that the access operation is complete. The status polling component 435 may be configured as or otherwise support a means for polling, after receiving the first message, for a first indication that the purge operation of the first type is complete.

In some examples, the message transmission component 440 may be configured as or otherwise support a means for transmitting, after transmitting the second command, one or more status requests that request information regarding a status of the purge operation, where transmitting the access command, polling for the first indication, or both are in accordance with the one or more status requests.

In some examples, the operation management component 445 may be configured as or otherwise support a means for selecting the first type of purge operation from a plurality of types of purge operations supported by the memory system, where the first type of purge operation includes a sliced purge operation and a second type of purge operation of the plurality of types of purge operations includes a continuous purge operation.

In some examples, the sliced purge operation supports executing access operations after a second time at which the purge operation is initiated and before a third time at which the purge operation is complete. In some examples, transmitting the access command is in accordance with the purge operation being the first type of purge operation including the sliced purge operation.

In some examples, the message transmission component 440 may be configured as or otherwise support a means for transmitting, after transmitting the access command, a second message that queries whether the purge operation of the first type is complete. In some examples, the status polling component 435 may be configured as or otherwise support a means for polling, in response to transmitting the second message, for a second indication, where the second indication indicates that the purge operation of the first type is not complete. In some examples, the message transmission component 440 may be configured as or otherwise support a means for transmitting, after polling for the second indication, a third message that queries whether the purge operation of the first type is complete, where polling for the first indication that the purge operation of the first type is complete is in accordance with transmitting the third message.

In some examples, the access command indicates a first priority associated with the access operation that is greater than a second priority associated with the purge operation.

In some examples, the data stored to the one or more blocks of memory cells of the memory system include invalid data.

In some examples, the described functionality of the host system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 420, or various components thereof, may be implemented at least in part by instructions (e.g., stored in memory, non-transitory computer-readable medium) executable by such at least one processor.

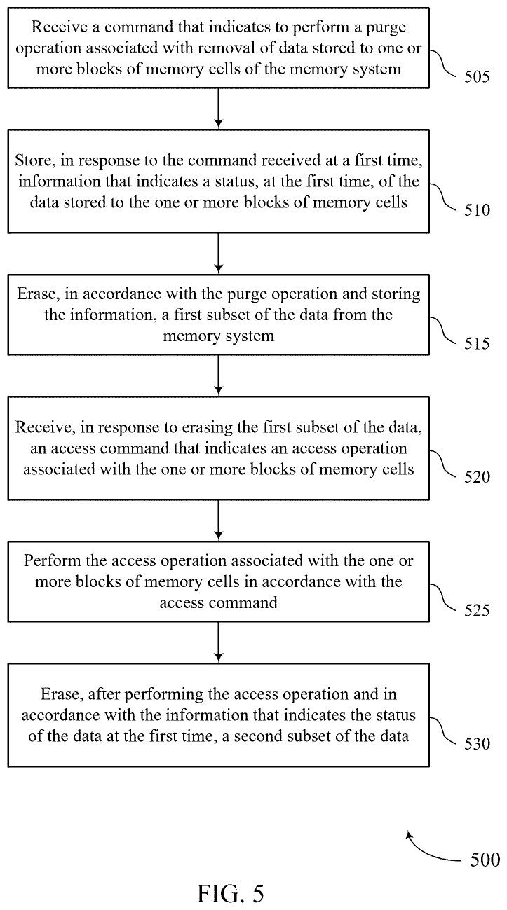

FIG. 5 shows a flowchart illustrating a method 500 that supports memory system purge operations with interleaved access commands in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include receiving a command that indicates to perform a purge operation associated with removal of data stored to one or more blocks of memory cells of the memory system. In some examples, aspects of the operations of 505 may be performed by a command reception component 325 as described with reference to FIG. 3.

At 510, the method may include storing, in response to the command received at a first time, information that indicates a status, at the first time, of the data stored to the one or more blocks of memory cells. In some examples, aspects of the operations of 510 may be performed by a data storage component 330 as described with reference to FIG. 3.

At 515, the method may include erasing, in accordance with the purge operation and storing the information, a first subset of the data from the memory system. In some examples, aspects of the operations of 515 may be performed by a data management component 335 as described with reference to FIG. 3.

At 520, the method may include receiving, in response to erasing the first subset of the data, an access command that indicates an access operation associated with the one or more blocks of memory cells. In some examples, aspects of the operations of 520 may be performed by a command reception component 325 as described with reference to FIG. 3.

At 525, the method may include performing the access operation associated with the one or more blocks of memory cells in accordance with the access command. In some examples, aspects of the operations of 525 may be performed by a memory access component 340 as described with reference to FIG. 3.

At 530, the method may include erasing, after performing the access operation and in accordance with the information that indicates the status of the data at the first time, a second subset of the data. In some examples, aspects of the operations of 530 may be performed by a data management component 335 as described with reference to FIG. 3.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command that indicates to perform a purge operation associated with removal of data stored to one or more blocks of memory cells of the memory system; storing, in response to the command received at a first time, information that indicates a status, at the first time, of the data stored to the one or more blocks of memory cells; erasing, in accordance with the purge operation and storing the information, a first subset of the data from the memory system; receiving, in response to erasing the first subset of the data, an access command that indicates an access operation associated with the one or more blocks of memory cells; performing the access operation associated with the one or more blocks of memory cells in accordance with the access command; and erasing, after performing the access operation and in accordance with the information that indicates the status of the data at the first time, a second subset of the data.

Aspect 2: The method, apparatus, or non-transitory computer-readable medium of aspect 1, further including operations, features, circuitry, logic, means, or instructions, or any combination thereof for selecting a first type of purge operation from a plurality of types of purge operations supported by the memory system in response to the command indicating the first type of purge operation, where the first type of purge operation includes a sliced purge operation and a second type of purge operation of the plurality of types of purge operations includes a continuous purge operation.

Aspect 3: The method, apparatus, or non-transitory computer-readable medium of aspect 2, where the sliced purge operation indicates that the memory system is capable of performing access operations after a second time at which the purge operation is initiated and before a third time at which the purge operation is complete and performing the access operation is in accordance with the purge operation being the first type of purge operation including the sliced purge operation.

Aspect 4: The method, apparatus, or non-transitory computer-readable medium of any of aspects 1 through 3, where erasing the second subset of the data includes operations, features, circuitry, logic, means, or instructions, or any combination thereof for erasing the second subset of the data in accordance with the information that indicates the status of the data at the first time and independent of the second status of the data at the second time.

Aspect 5: The method, apparatus, or non-transitory computer-readable medium of any of aspects 1 through 4, further including operations, features, circuitry, logic, means, or instructions, or any combination thereof for receiving, after receiving the access command and prior to erasing the second subset of the data, a first message that queries whether the purge operation is complete and setting, in response to receiving the first message, a value of polling circuitry to a first value, the first value indicating that the purge operation is not complete in accordance with at least some of the data indicated via the command remaining in the one or more blocks of memory cells, the at least some of the data including at least the second subset of the data.

Aspect 6: The method, apparatus, or non-transitory computer-readable medium of aspect 5, further including operations, features, circuitry, logic, means, or instructions, or any combination thereof for receiving, after erasing the second subset of the data, a second message that queries whether the purge operation is complete and setting, in response to receiving the second message, the value of the polling circuitry to a second value, the second value indicating that the purge operation is complete in accordance with an absence, after erasing the second subset of the data, of any of the data indicated via the command in the one or more blocks of memory cells, where the second subset of the data includes a final subset of the data to be erased.

Aspect 7: The method, apparatus, or non-transitory computer-readable medium of any of aspects 1 through 6, where performing the access operation includes operations, features, circuitry, logic, means, or instructions, or any combination thereof for performing the access operation prior to erasing the second subset of the data in accordance with a first priority associated with the access operation being greater than a second priority associated with the purge operation.

Aspect 8: The method, apparatus, or non-transitory computer-readable medium of any of aspects 1 through 7, where storing the information that indicates the status, at the first time, of the data includes operations, features, circuitry, logic, means, or instructions, or any combination thereof for obtaining a snapshot of the data stored to the one or more blocks of memory cells and storing the snapshot, where the information includes the snapshot.

Aspect 9: The method, apparatus, or non-transitory computer-readable medium of any of aspects 1 through 8, where the status, at the first time, indicates that the first subset of the data and the second subset of the data include invalid data stored to the one or more blocks of memory cells.

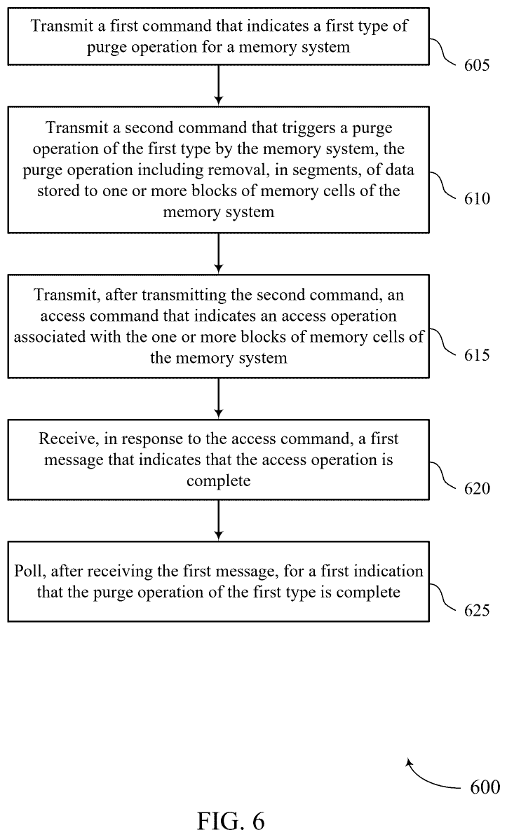

FIG. 6 shows a flowchart illustrating a method 600 that supports memory system purge operations with interleaved access commands in accordance with examples as disclosed herein. The operations of method 600 may be implemented by a host system or its components as described herein. For example, the operations of method 600 may be performed by a host system as described with reference to FIGS. 1 through 2 and 4. In some examples, a host system may execute a set of instructions to control the functional elements of the device to perform the described functions. Additionally, or alternatively, the host system may perform aspects of the described functions using special-purpose hardware.

At 605, the method may include transmitting a first command that indicates a first type of purge operation for a memory system. In some examples, aspects of the operations of 605 may be performed by a command transmission component 425 as described with reference to FIG. 4.

At 610, the method may include transmitting a second command that triggers a purge operation of the first type by the memory system, the purge operation including removal, in segments, of data stored to one or more blocks of memory cells of the memory system. In some examples, aspects of the operations of 610 may be performed by a command transmission component 425 as described with reference to FIG. 4.

At 615, the method may include transmitting, after transmitting the second command, an access command that indicates an access operation associated with the one or more blocks of memory cells of the memory system. In some examples, aspects of the operations of 615 may be performed by a command transmission component 425 as described with reference to FIG. 4.

At 620, the method may include receiving, in response to the access command, a first message that indicates that the access operation is complete. In some examples, aspects of the operations of 620 may be performed by a message reception component 430 as described with reference to FIG. 4.

At 625, the method may include polling, after receiving the first message, for a first indication that the purge operation of the first type is complete. In some examples, aspects of the operations of 625 may be performed by a status polling component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for transmitting a first command that indicates a first type of purge operation for a memory system; transmitting a second command that triggers a purge operation of the first type by the memory system, the purge operation including removal, in segments, of data stored to one or more blocks of memory cells of the memory system; transmitting, after transmitting the second command, an access command that indicates an access operation associated with the one or more blocks of memory cells of the memory system; receiving, in response to the access command, a first message that indicates that the access operation is complete; and polling, after receiving the first message, for a first indication that the purge operation of the first type is complete.

Aspect 11: The method, apparatus, or non-transitory computer-readable medium of aspect 10, further including operations, features, circuitry, logic, means, or instructions, or any combination thereof for transmitting, after transmitting the second command, one or more status requests that request information regarding a status of the purge operation, where transmitting the access command, polling for the first indication, or both are in accordance with the one or more status requests.

Aspect 12: The method, apparatus, or non-transitory computer-readable medium of any of aspects 10 through 11, further including operations, features, circuitry, logic, means, or instructions, or any combination thereof for selecting the first type of purge operation from a plurality of types of purge operations supported by the memory system, where the first type of purge operation includes a sliced purge operation and a second type of purge operation of the plurality of types of purge operations includes a continuous purge operation.

Aspect 13: The method, apparatus, or non-transitory computer-readable medium of aspect 12, where the sliced purge operation supports executing access operations after a second time at which the purge operation is initiated and before a third time at which the purge operation is complete and transmitting the access command is in accordance with the purge operation being the first type of purge operation including the sliced purge operation.

Aspect 14: The method, apparatus, or non-transitory computer-readable medium of any of aspects 10 through 13, further including operations, features, circuitry, logic, means, or instructions, or any combination thereof for transmitting, after transmitting the access command, a second message that queries whether the purge operation of the first type is complete; polling, in response to transmitting the second message, for a second indication, where the second indication indicates that the purge operation of the first type is not complete; and transmitting, after polling for the second indication, a third message that queries whether the purge operation of the first type is complete, where polling for the first indication that the purge operation of the first type is complete is in accordance with transmitting the third message.

Aspect 15: The method, apparatus, or non-transitory computer-readable medium of any of aspects 10 through 14, where the access command indicates a first priority associated with the access operation that is greater than a second priority associated with the purge operation.

Aspect 16: The method, apparatus, or non-transitory computer-readable medium of any of aspects 10 through 15, where the data stored to the one or more blocks of memory cells of the memory system include invalid data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit according to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a command that indicates to perform a purge operation associated with removal of data stored to one or more blocks of memory cells of the memory system;
store, in response to the command received at a first time, information that indicates a status, at the first time, of the data stored to the one or more blocks of memory cells;
erase, in accordance with the purge operation and storing the information, a first subset of the data from the memory system;
receive, in response to erasing the first subset of the data, an access command that indicates an access operation associated with the one or more blocks of memory cells;
perform the access operation associated with the one or more blocks of memory cells in accordance with the access command; and
erase, after performing the access operation and in accordance with the information that indicates the status of the data at the first time, a second subset of the data.

2. The memory system of claim 1, wherein the processing circuitry is further configured to cause the memory system to:
select a first type of purge operation from a plurality of types of purge operations supported by the memory system in response to the command indicating the first type of purge operation, wherein the first type of purge operation comprises a sliced purge operation and a second type of purge operation of the plurality of types of purge operations comprises a continuous purge operation.

3. The memory system of claim 2, wherein the sliced purge operation indicates that the memory system is capable of performing access operations after a second time at which the purge operation is initiated and before a third time at which the purge operation is complete, and wherein performing the access operation is in accordance with the purge operation being the first type of purge operation comprising the sliced purge operation.

4. The memory system of claim 1, wherein the access operation modifies the status of the data to a second status of the data at a second time that is different from the status of the data at the first time, and wherein, to erase the second subset of the data, the processing circuitry is configured to cause the memory system to:
erase the second subset of the data in accordance with the information that indicates the status of the data at the first time and independent of the second status of the data at the second time.

5. The memory system of claim 1, wherein the processing circuitry is further configured to cause the memory system to:
receive, after receiving the access command and prior to erasing the second subset of the data, a first message that queries whether the purge operation is complete; and
set, in response to receiving the first message, a value of polling circuitry to a first value, the first value indicating that the purge operation is not complete in accordance with at least some of the data indicated via the command remaining in the one or more blocks of memory cells, the at least some of the data comprising at least the second subset of the data.

6. The memory system of claim 5, wherein the processing circuitry is further configured to cause the memory system to:
receive, after erasing the second subset of the data, a second message that queries whether the purge operation is complete; and
set, in response to receiving the second message, the value of the polling circuitry to a second value, the second value indicating that the purge operation is complete in accordance with an absence, after erasing the second subset of the data, of any of the data indicated via the command in the one or more blocks of memory cells, wherein the second subset of the data comprises a final subset of the data to be erased.

7. The memory system of claim 1, wherein, to perform the access operation, the processing circuitry is configured to cause the memory system to:
perform the access operation prior to erasing the second subset of the data in accordance with a first priority associated with the access operation being greater than a second priority associated with the purge operation.

8. The memory system of claim 1, wherein, to store the information that indicates the status, at the first time, of the data, the processing circuitry is configured to cause the memory system to:
obtain a snapshot of the data stored to the one or more blocks of memory cells; and
store the snapshot, wherein the information comprises the snapshot.

9. The memory system of claim 1, wherein the status, at the first time, indicates that the first subset of the data and the second subset of the data comprise invalid data stored to the one or more blocks of memory cells.

10. A host system, comprising:
one or more interfaces comprising one or more signal paths operable for communications with one or more memory systems; and
processing circuitry coupled with the one or more interfaces and configured to cause the host system to:
transmit a first command that indicates a first type of purge operation for a memory system;
transmit a second command that triggers a purge operation of the first type by the memory system, the purge operation comprising removal, in segments, of data stored to one or more blocks of memory cells of the memory system;
transmit, after transmitting the second command, an access command that indicates an access operation associated with the one or more blocks of memory cells of the memory system;
receive, in response to the access command, a first message that indicates that the access operation is complete; and
poll, after receiving the first message, for a first indication that the purge operation of the first type is complete.

11. The host system of claim 10, wherein the processing circuitry is further configured to cause the host system to:
transmit, after transmitting the second command, one or more status requests that request information regarding a status of the purge operation, wherein transmitting the access command, polling for the first indication, or both are in accordance with the one or more status requests.

12. The host system of claim 10, wherein the processing circuitry is further configured to cause the host system to:
select the first type of purge operation from a plurality of types of purge operations supported by the memory system, wherein the first type of purge operation comprises a sliced purge operation and a second type of purge operation of the plurality of types of purge operations comprises a continuous purge operation.

13. The host system of claim 12, wherein the sliced purge operation supports executing access operations after a second time at which the purge operation is initiated and before a third time at which the purge operation is complete, and wherein transmitting the access command is in accordance with the purge operation being the first type of purge operation comprising the sliced purge operation.

14. The host system of claim 10, wherein the processing circuitry is further configured to cause the host system to:
transmit, after transmitting the access command, a second message that queries whether the purge operation of the first type is complete;
poll, in response to transmitting the second message, for a second indication, wherein the second indication indicates that the purge operation of the first type is not complete; and
transmit, after polling for the second indication, a third message that queries whether the purge operation of the first type is complete, wherein polling for the first indication that the purge operation of the first type is complete is in accordance with transmitting the third message.

15. The host system of claim 10, wherein the access command indicates a first priority associated with the access operation that is greater than a second priority associated with the purge operation.

16. The host system of claim 10, wherein the data stored to the one or more blocks of memory cells of the memory system comprise invalid data.

17. A non-transitory computer-readable medium storing code comprising instructions which, when executed by one or more processors of a memory system, cause the memory system to:
receive a command that indicates to perform a purge operation associated with removal of data stored to one or more blocks of memory cells of the memory system;
store, in response to the command received at a first time, information that indicates a status, at the first time, of the data stored to the one or more blocks of memory cells;
erase, in accordance with the purge operation and storing the information, a first subset of the data from the memory system;
receive, in response to erasing the first subset of the data, an access command that indicates an access operation associated with the one or more blocks of memory cells;
perform the access operation associated with the one or more blocks of memory cells in response to the access command; and
erase, after performing the access operation and in accordance with the information that indicates the status of the data at the first time, a second subset of the data.

18. The non-transitory computer-readable medium of claim 17, wherein the instructions, when executed by the one or more processors of the memory system, further cause the memory system to:
select a first type of purge operation from a plurality of types of purge operations supported by the memory system in accordance with the command indicating the first type of purge operation, wherein the first type of purge operation comprises a sliced purge operation and a second type of purge operation of the plurality of types of purge operations comprises a continuous purge operation.

19. The non-transitory computer-readable medium of claim 18, wherein the sliced purge operation indicates that the memory system is capable of performing access operations after a second time at which the purge operation is initiated and before a third time at which the purge operation is complete, and wherein performing the access operation is in accordance with the purge operation being the first type of purge operation comprising the sliced purge operation.

20. The non-transitory computer-readable medium of claim 17, wherein the access operation modifies the status of the data to a second status of the data at a second time that is different from the status of the data at the first time, and wherein the instructions to erase the second subset of the data, when executed by the one or more processors of the memory system, cause the memory system to:
erase the second subset of the data in accordance with the information that indicates the status of the data at the first time and independent of the second status of the data at the second time.

21. The non-transitory computer-readable medium of claim 17, wherein the instructions, when executed by the one or more processors of the memory system, further cause the memory system to:
receive, after receiving the access command and prior to erasing the second subset of the data, a first message that queries whether the purge operation is complete; and
set, in response to receiving the first message, a value of polling circuitry to a first value, the first value indicating that the purge operation is not complete in accordance with at least some of the data indicated via the command remaining in the one or more blocks of memory cells, the at least some of the data comprising at least the second subset of the data.

22. The non-transitory computer-readable medium of claim 21, wherein the instructions, when executed by the one or more processors of the memory system, further cause the memory system to:
receive, after erasing the second subset of the data, a second message that queries whether the purge operation is complete; and
set, in response to receiving the second message, the value of the polling circuitry to a second value, the second value indicating that the purge operation is complete in accordance with an absence, after erasing the second subset of the data, of any of the data indicated via the command in the one or more blocks of memory cells, wherein the second subset of the data comprises a final subset of the data to be erased.

23. The non-transitory computer-readable medium of claim 17, wherein the instructions to perform the access operation, when executed by the one or more processors of the memory system, cause the memory system to:
perform the access operation prior to erasing the second subset of the data in accordance with a first priority associated with the access operation being greater than a second priority associated with the purge operation.

24. The non-transitory computer-readable medium of claim 17, wherein the instructions to store the information that indicates the status, at the first time, of the data, when executed by the one or more processors of the memory system, cause the memory system to:
obtain a snapshot of the data stored to the one or more blocks of memory cells; and
store the snapshot, wherein the information comprises the snapshot.

25. The non-transitory computer-readable medium of claim 17, wherein the status, at the first time, indicates that the first subset of the data and the second subset of the data comprise invalid data stored to the one or more blocks of memory cells.
